(19) United States
(12) Patent Application Publication
(10) Pub. No.: US 2010/0306453 A1
(43) Pub. Date: Dec. 2, 2010

(54) METHOD FOR OPERATING A PORTION OF AN EXECUTABLE PROGRAM IN AN EXECUTABLE NON-VOLATILE MEMORY

(76) Inventor: Edward Doller, El Dorado Hills, CA (US)

Correspondence Address: Gerbera/BSTZ;Blakely Sokoloff Taylor & Zafman LLP, 1279 OAKMEAD PARKWAY, SUNNYVALE, CA, 94085, US

(21) Appl. No.: 12/477,017

(22) Filed: Jun. 2, 2009

(51) Int. Cl. G06F 12/02

(52) U.S. Cl. 711/103; 711/E12.008

(57) ABSTRACT

A method for operating at least a portion of an executable program in an executable non-volatile memory is described. The method includes determining, by a user input, at least a portion of an executable program for pinning in the executable non-volatile memory. The portion of the executable program is pinned to the executable non-volatile memory. The portion of the executable program is then executed from the executable non-volatile memory.

### TECHNICAL FIELD

Embodiments of the invention are in the field of non-volatile memory cells and, in particular, methods for operating at least a portion of an executable program in an executable non-volatile memory.

### BACKGROUND

Embedded SRAM and DRAM have problems with non-volatility and soft error rates, while embedded FLASH memories require additional masking layers or processing steps during manufacture, require high-voltage for programming, and have issues with endurance and reliability. Phase-Change Memory (PCM) overcomes the criticality of the above mentioned parameters and exhibits favorable write speeds, small cell sizes, simpler circuitries and a fabrication compatibility with the Complementary Metal-Oxide-Semiconductor (CMOS) process. However, additional improvements are needed in the evolution of the PCM technology.

### BRIEF DESCRIPTION OF THE DRAWINGS

FIG. 1 illustrates a Flowchart representing operations in a method for operating at least a portion of an executable program in an executable non-volatile memory, in accordance with an embodiment of the present invention.

FIG. 2 illustrates a Flowchart representing operations in a method for operating at least a portion of an executable program in an executable non-volatile memory, in accordance with an embodiment of the present invention.

FIG. 3 illustrates a block diagram of an example of a computer system configured for operating at least a portion of an executable program in an executable non-volatile memory, in accordance with an embodiment of the present invention.

FIG. 4 illustrates a schematic representation of a wireless architecture that incorporates an executable memory configured to be included in a method for operating at least a portion of an executable program in the executable non-volatile memory, in accordance with an embodiment of the present invention.

FIG. 5 illustrates a phase change memory cell in an array of phase-change memory cells configured to be included in a method for operating at least a portion of an executable program in the array of phase-change memory cells, in accordance with an embodiment of the present invention.

### DETAILED DESCRIPTION

A method for operating at least a portion of an executable program in an executable non-volatile memory is described herein. In the following description, numerous specific details are set forth, such as specific phase-change memory cell array sizes, in order to provide a thorough understanding of embodiments of the present invention. It will be apparent to one skilled in the art that embodiments of the present invention may be practiced without these specific details. In other instances, well-known operations, such as methods of program execution, are not described in detail in order to not unnecessarily obscure embodiments of the present invention. Furthermore, it is to be understood that the various embodiments shown in the Figures are illustrative representations and are not necessarily drawn to scale.

Disclosed herein is a method for operating at least a portion of an executable program in an executable non-volatile memory. In one embodiment, the method includes determining, by a user input, at least a portion of an executable program for pinning in the executable non-volatile memory. The portion of the executable program is pinned to the executable non-volatile memory. The portion of the executable program is then executed from the executable non-volatile memory. In another embodiment, profiling is performed by an operating system to determine at least a portion of an executable program for pinning in the executable non-volatile memory. The portion of the executable program is pinned to the executable non-volatile memory. Subsequently, the portion of the executable program is executed from the executable non-volatile memory. In one embodiment, a machine-accessible storage medium has instructions stored thereon which cause a data processing system to perform a method for operating at least a portion of an executable program in an executable non-volatile memory. The method includes applying a user input or an operating system profile to determine at least a portion of an executable program for pinning in the executable non-volatile memory. The portion of the executable program is pinned to the executable non-volatile memory. Subsequently, the portion of the executable program is executed from the executable non-volatile memory. In another embodiment, a wireless communication device includes a transceiver to receive over-the-air signals, a processor core coupled to the transceiver, and an executable non-volatile memory embedded with at least the first processor core. The executable non-volatile memory is configured to be included in a method for operating at least a portion of an executable program in the executable non-volatile memory. The method includes applying a user input or an operating system profile to determine at least a portion of an executable program for pinning in the executable non-volatile memory. The portion of the executable program is pinned to the executable non-volatile memory. Subsequently, the portion of the executable program is executed from the executable non-volatile memory.

Typical computing and communication platforms code, e.g. software applications, often get loaded into executable memory such as ‘not-OR’ (NOR) memory or dynamic random-access memory (DRAM) when executed. Upon closure of or removal of power from the application, the fate of the code (e.g., cleared or not cleared) from the executable memory may be under the control of an operating system (O/S) despite the possibility of the existence of user priorities. In accordance with an embodiment of the present invention, a separate program or O/S is configured to allow a user to prioritize and keep executable applications in a memory. In an embodiment, this approach enables realization of a faster time to execution. In one embodiment, determining what portion of an executable program (or which entire executable programs from a menu of executable programs) is performed by user prioritization. In another embodiment, determining what portion of an executable program (or which entire executable programs from a menu of executable programs) is performed by having an O/S prioritize based on application profiling, e.g. the number of times the application has been executed in the past.

The computing industry may be driving toward systems where execution of executable programs is performed in a non-volatile memory device, as opposed to, say, back and forth from a hard-drive or having to go to separate random-access memory (RAM). However, in accordance with an embodiment of the present invention, the non-volatile memory device cannot be fabricated (or may be too costly to produce) to a size workable for handling all executable programs selected by a user or demanded by an associated operating system. Accordingly, in one embodiment, via a user interface or an operating system, certain executable programs or portions thereof are pinned to an executable non-volatile memory. In an embodiment, the executable memory can experience a host of power-down and power-up events while retaining the pinned executable software. This is in contrast to, say, having the executable program (or the portion thereof) residing on RAM and then disappearing during power-down and power-up events. Thus, in an embodiment, beyond merely pinning a data set, an executable program or portion thereof is pinned and is executed from the location where it is pinned. In a specific embodiment, the executable program or portion thereof is an executable program such as, but not limited to, a conventional executable program, a portion of software code or a portion of an operating system.

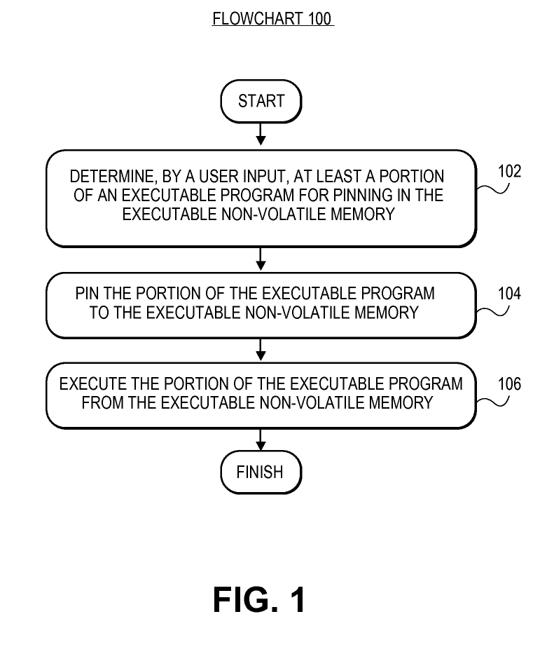

Determining at least a portion of an executable program for pinning in an executable memory may be performed by applying a user input. FIG. 1 illustrates a Flowchart 100 representing operations in a method for operating at least a portion of an executable program in an executable non-volatile memory, in accordance with an embodiment of the present invention.

Referring to operation 102 of Flowchart 100, a computer-implemented method for operating at least a portion of an executable program in an executable non-volatile memory includes determining, by a user input, at least a portion of an executable program for pinning in the executable non-volatile memory. In accordance with an embodiment of the present invention, an executable memory is defined herein as a memory having or exhibiting random initial access that is quick enough to keep pace with an associated processor, e.g. a memory having an efficiency for executing code. In one embodiment, the executable program is a program such as, but not limited to, Excel, PowerPoint, Word or a portable document format (PDF) program. In an embodiment, the term ‘at least a portion’ of an executable program is defined herein as a portion of a single executable program or an entire executable program, such as an entire executable program selected from a menu of multiple executable programs. In an embodiment, the term ‘user input’ is used herein to refer to an input such as, but not limited to, one from the system choosing which application (executable) to remain in the executable memory.

In accordance with an embodiment of the present invention, the executable non-volatile memory includes or is a phase-change memory array. In a specific embodiment, the phase-change memory array has a size such as, but not limited to, 4 gigabytes, 8 gigabytes or 16 gigabytes. Phase-change memory may be more random-access memory-like (RAM-like) than other non-volatile memories. Also, phase-change memory may not need erasing prior to writing and the number of times the phase-change memory can be erased may be significantly greater than for other non-volatile memories. However, in an alternative embodiment of the present invention, the executable non-volatile memory is a NOR flash memory device.

Referring to operation 104 of Flowchart 100, the computer-implemented method for operating at least a portion of an executable program in an executable non-volatile memory includes pinning the portion of the executable program to the executable non-volatile memory. In accordance with an embodiment of the present invention, the term ‘pinning’ is defined herein as the executable code remaining resident in the executable memory, the executable code ready for execution. In an embodiment, the computer-implemented method further includes, prior to the pinning and subsequent to the executing (the latter is described below in association with operation 106 of Flowchart 100), removing power from the executable non-volatile memory and the restoring power to the executable non-volatile memory. Thus, in one embodiment, the selected portion of the executable program, or the entire executable program, is retained in the executable memory even in the absence of power. In that embodiment, upon powering up the executable memory, an O/S need only reference the executable memory for the executable program (or portion thereof), saving precious computing time and making such a power-up event more efficient.

Referring to operation 106 of Flowchart 100, the computer-implemented method for operating at least a portion of an executable program in an executable non-volatile memory includes subsequently executing the portion of the executable program from the executable non-volatile memory. In accordance with an embodiment of the present invention, an O/S associated with the executable memory is configured to reference the portion of an executable program from the executable memory, and not from anywhere else. Thus, in one embodiment, the O/S is configured to go to the executable memory for execution of the portion of an executable program stored in the executable memory, rather than independently compiling that portion of an executable program. In an embodiment, the term ‘O/S’ is defined herein as software that controls execution of a computer program or of multiple computer programs, e.g. software that controls a layer between hardware applications and user controls. In one embodiment, the O/S is software such as, but not limited to, Mac O/S, UNIX O/S, LINUX O/S or Windows O/S.

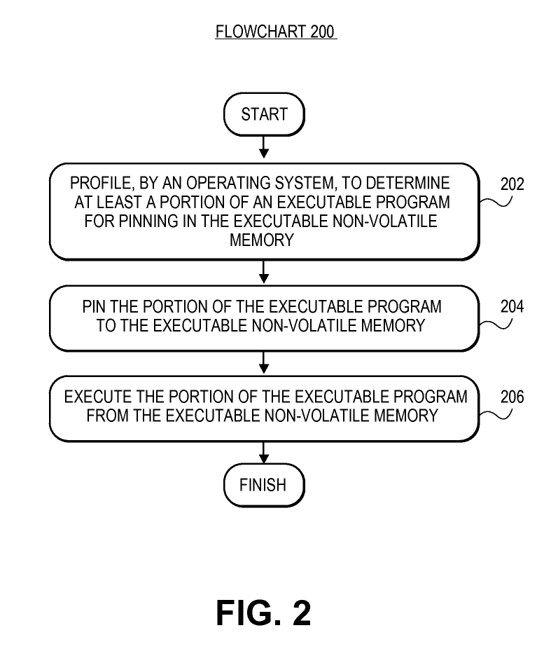

Determining at least a portion of an executable program for pinning in an executable memory may be performed by profiling via an operating system. FIG. 2 illustrates a Flowchart 200 representing operations in a method for operating at least a portion of an executable program in an executable non-volatile memory, in accordance with an embodiment of the present invention.

Referring to operation 202 of Flowchart 200, a computer-implemented method for operating at least a portion of an executable program in an executable non-volatile memory includes profiling, by an operating system, to determine at least a portion of an executable program for pinning in the executable non-volatile memory. In accordance with an embodiment of the present invention, the profiling includes determining the number of times the executable program has been accessed in a past timeframe. In an embodiment, the terms ‘executable memory,’ ‘at least a portion’ of an executable program and ‘user input’ are defined according to the definitions provided in association with operation 102 of Flowchart 100. In one embodiment, the executable program is a program such as, but not limited to, Excel, PowerPoint, Word or a portable document format (PDF) program.

In accordance with an embodiment of the present invention, the executable non-volatile memory includes or is a phase-change memory array. In a specific embodiment, the phase-change memory array has a size such as, but not limited to, 4 gigabytes, 8 gigabytes or 16 gigabytes. Phase-change memory may be more random-access memory-like (RAM-like) than other non-volatile memories. Also, phase-change memory may not need erasing prior to writing and the number of times the phase-change memory can be erased may be significantly greater than for other non-volatile memories. However, in an alternative embodiment of the present invention, the executable non-volatile memory is a NOR flash memory device.

Referring to operation 204 of Flowchart 200, the computer-implemented method for operating at least a portion of an executable program in an executable non-volatile memory includes pinning the portion of the executable program to the executable non-volatile memory. In accordance with an embodiment of the present invention, the term ‘pinning’ is defined according to the definition provided in association with operation 104 of Flowchart 100. In an embodiment, the computer-implemented method further includes, prior to the pinning and subsequent to the executing (the latter is described below in association with operation 206 of Flowchart 200), removing power from the executable non-volatile memory and the restoring power to the executable non-volatile memory. Thus, in one embodiment, the selected portion of the, or the entire, executable program is retained in the executable memory even in the absence of power. In that embodiment, upon powering up the executable memory, an O/S need only reference the executable memory for the executable program (or portion thereof), saving precious computing time and making such a power-up event more efficient.

Referring to operation 206 of Flowchart 200, the computer-implemented method for operating at least a portion of an executable program in an executable non-volatile memory includes subsequently executing the portion of the executable program from the executable non-volatile memory. In accordance with an embodiment of the present invention, an O/S associated with the executable memory is configured to reference the portion of an executable program from the executable memory, and not from anywhere else. Thus, in one embodiment, the O/S is configured to go to the executable memory for execution of the portion of an executable program stored in the executable memory, rather than independently compiling that portion of an executable program. In an embodiment, the term ‘O/S’ is defined herein as software that controls execution of a computer program or of multiple computer programs, e.g. software that controls a layer between hardware applications and user controls. In one embodiment, the O/S is software such as, but not limited to, Mac O/S, UNIX O/S, LINUX O/S or Windows O/S.

In an embodiment, the present invention is provided as a computer program product, or software product, that includes a machine-readable medium having stored thereon instructions, which is used to program a computer system (or other electronic devices) to perform a process according to embodiments of the present invention. A machine-readable medium may include any mechanism for storing or transmitting information in a form readable by a machine (e.g., a computer). For example, in an embodiment, a machine-readable (e.g., computer-readable) medium includes a machine (e.g., a computer) readable storage medium (e.g., read only memory (‘ROM’), random access memory (‘RAM’), magnetic disk storage media, optical storage media, flash memory devices, etc.), a machine (e.g., computer) readable transmission medium (electrical, optical, acoustical or other form of signals (e.g., infrared signals, digital signals, etc.)), etc. In an embodiment, use of the term ‘computer-implemented’ herein means processor-implemented. In one embodiment, at least one of the methods described herein is implemented in a portable device, such as a cellular phone, which does not have a computer per se but does have a processor.

In accordance with an embodiment of the present invention, a machine-accessible storage medium has instructions stored thereon which cause a data processing system to perform a method for operating at least a portion of an executable program in an executable non-volatile memory. In an embodiment, the method includes applying a user input or an operating system profile to determine at least a portion of an executable program for pinning in the executable non-volatile memory. The method includes pinning the portion of the executable program to the executable non-volatile memory. The method also includes, subsequently, executing the portion of the executable program from the executable non-volatile memory. In one embodiment, the operating system profile is applied and generating the operating system profile includes determining the number of times the executable program has been accessed in a past timeframe. In another embodiment, the method further includes, prior to the pinning and subsequent to the executing, removing power from the executable non-volatile memory and then restoring power to the executable non-volatile memory. In one embodiment, the executable non-volatile memory includes a phase-change memory array. In another embodiment, the executable non-volatile memory is a NOR flash memory device.

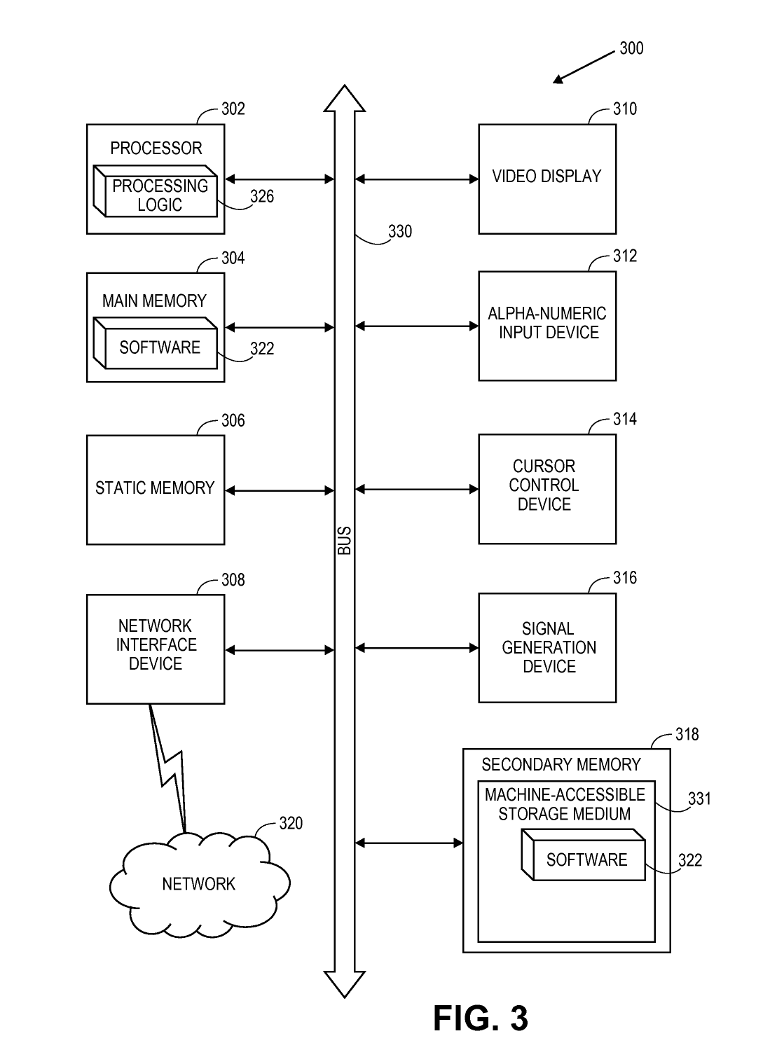

FIG. 3 illustrates a diagrammatic representation of a machine in the form of a computer system 300 within which a set of instructions, for causing the machine to perform any one or more of the methodologies discussed herein, is executed. For example, in accordance with an embodiment of the present invention, FIG. 3 illustrates a block diagram of an example of a computer system configured for operating at least a portion of an executable program in an executable non-volatile memory. In alternative embodiments, the machine is connected (e.g., networked) to other machines in a Local Area Network (LAN), an intranet, an extranet, or the Internet. In an embodiment, the machine operates in the capacity of a server or a client machine in a client-server network environment, or as a peer machine in a peer-to-peer (or distributed) network environment. In an embodiment, the machine is a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term ‘machine’ shall also be taken to include any collection of machines (e.g., computers or processors) that individually or jointly execute a set (or multiple sets) of instructions to perform any one or more of the methodologies discussed herein.

The example of a computer system 300 includes a processor 302, a main memory 304 (e.g., read-only memory (ROM), flash memory, dynamic random access memory (DRAM) such as synchronous DRAM (SDRAM) or Rambus DRAM (RDRAM), etc.), a static memory 306 (e.g., flash memory, static random access memory (SRAM), etc.), and a secondary memory 318 (e.g., a data storage device), which communicate with each other via a bus 330.

Processor 302 represents one or more general-purpose processing devices such as a microprocessor, central processing unit, or the like. More particularly, in an embodiment, the processor 302 is a complex instruction set computing (CISC) microprocessor, reduced instruction set computing (RISC) microprocessor, very long instruction word (VLIW) microprocessor, processor implementing other instruction sets, or processors implementing a combination of instruction sets. In one embodiment, processor 302 is one or more special-purpose processing devices such as an application specific integrated circuit (ASIC), a field programmable gate array (FPGA), a digital signal processor (DSP), network processor, or the like. Processor 302 executes the processing logic 326 for performing the operations discussed herein.

In an embodiment, the computer system 300 further includes a network interface device 308. In one embodiment, the computer system 300 also includes a video display unit 310 (e.g., a liquid crystal display (LCD) or a cathode ray tube (CRT)), an alphanumeric input device 312 (e.g., a keyboard), a cursor control device 314 (e.g., a mouse), and a signal generation device 316 (e.g., a speaker).

In an embodiment, the secondary memory 318 includes a machine-accessible storage medium (or more specifically a computer-readable storage medium) 331 on which is stored one or more sets of instructions (e.g., software 322) embodying any one or more of the methodologies or functions described herein. In an embodiment, the software 322 resides, completely or at least partially, within the main memory 304 or within the processor 302 during execution thereof by the computer system 300, the main memory 304 and the processor 302 also constituting machine-readable storage media. In one embodiment, the software 322 is further transmitted or received over a network 320 via the network interface device 308.

While the machine-accessible storage medium 331 is shown in an embodiment to be a single medium, the term ‘machine-readable storage medium’ should be taken to include a single medium or multiple media (e.g., a centralized or distributed database, or associated caches and servers) that store the one or more sets of instructions. The term ‘machine-readable storage medium’ shall also be taken to include any medium that is capable of storing or encoding a set of instructions for execution by the machine and that cause the machine to perform any one or more of the methodologies of embodiments of the present invention. The term ‘machine-readable storage medium’ shall accordingly be taken to include, but not be limited to, solid-state memories, and optical and magnetic media.

In accordance with another embodiment of the present invention, a wireless communication device is configured to perform a method for operating at least a portion of an executable program in an executable non-volatile memory. In an embodiment, the wireless communication device includes a transceiver to receive over-the-air signals, a processor core coupled to the transceiver, and an executable non-volatile memory embedded with at least the first processor core. In one embodiment, it is the executable non-volatile memory that is configured to be included in a method for operating at least a portion of an executable program in the executable non-volatile memory. In an embodiment, the method includes applying a user input or an operating system profile to determine at least a portion of an executable program for pinning in the executable non-volatile memory. The method also includes pinning the portion of the executable program to the executable non-volatile memory. The method then includes subsequently executing the portion of the executable program from the executable non-volatile memory.

In one embodiment of the wireless communication device, the operating system profile is applied and generating the operating system profile includes determining the number of times the executable program has been accessed in a past timeframe. In another embodiment of the wireless communication device, the method further includes, prior to the pinning and subsequent to the executing, removing power from the executable non-volatile memory and then restoring power to the executable non-volatile memory. In one embodiment of the wireless communication device, the executable non-volatile memory includes a phase-change memory array. In another embodiment of the wireless communication device, the executable non-volatile memory is a NOR flash memory device.

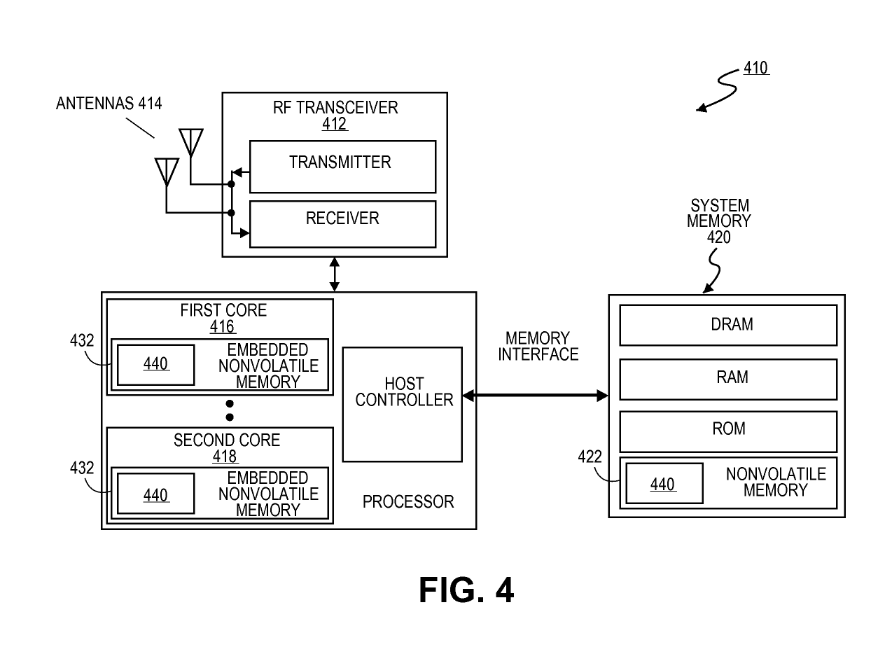

FIG. 4 illustrates a schematic representation of a wireless architecture that incorporates an executable memory configured to be included in a method for operating at least a portion of an executable program in the executable non-volatile memory, in accordance with an embodiment of the present invention. It should be noted, however, that embodiments of the present invention are not limited to wireless communication embodiments and other, non-wireless applications may be used in conjunction with embodiments of the present invention.

Referring to FIG. 4, a communications device 410 includes one or more antenna structures 414 to allow radios to communicate with other over-the-air communication devices. As such, communications device 410 may operate as a cellular device or a device that operates in wireless networks such as, for example, Wireless Fidelity (Wi-Fi) that provides the underlying technology of Wireless Local Area Network (WLAN) based on the IEEE 802.11 specifications, WiMax and Mobile WiMax based on IEEE 802.16-2005, Wideband Code Division Multiple Access (WCDMA), and Global System for Mobile Communications (GSM) networks, although embodiments of the present invention are not limited to operate in only these networks. In an embodiment, the radio subsystems co-located in the same platform of communications device 410 provide the capability of communicating with different frequency bands in an RF/location space with other devices in a network.

It should be understood that the scope of embodiments of the present invention are not limited by the types of, the number of, or the frequency of the communication protocols that may be used by communications device 410. However, by way of example, the embodiment illustrates the coupling of antenna structure 414 to a transceiver 412 to accommodate modulation or demodulation. In general, analog front end transceiver 412 may be a stand-alone Radio Frequency (RF) discrete or integrated analog circuit, or transceiver 412 may be embedded with a processor having one or more processor cores 416 and 418. In an embodiment, the multiple cores allow processing workloads to be shared across the cores and handle baseband functions and application functions. An interface may be used to provide communication or information between the processor and the memory storage in a system memory 420. Although the scope of embodiments of the present invention are not limited in this respect, the interface may include serial or parallel buses to share information along with control signal lines to be used to provide handshaking between the processor and system memory 420.

The system memory 420 may optionally be used to store instructions that are executed by the processor during the operation of wireless communication device 410, and may be used to store user data such as the conditions for when a message is to be transmitted by wireless communication device 410 or the actual data to be transmitted. For example, the instructions stored in system memory 420 may be used to perform wireless communications, provide security functionality for communication device 410, user functionality such as calendaring, email, internet browsing, etc. System memory 420 may be provided by one or more different types of memory and may include both volatile and a non-volatile memory 422 having a phase change material. Non-volatile memory 422 may be referred to as a Phase Change Memory (PCM), Phase-Change Random Access Memory (PRAM or PCRAM), Ovonic Unified Memory (OUM) or Chalcogenide Random Access Memory (C-RAM).

The volatile and nonvolatile memories may be combined in a stacking process to reduce the footprint on a board, packaged separately, or placed in a multi-chip package with the memory component placed on top of the processor. The embodiment also illustrates that one or more of the processor cores may be embedded with nonvolatile memory 432. In accordance with an embodiment of the present invention, at least one of non-volatile memory 422 or 432 is configured to operate at least a portion 440 of an executable program in the executable non-volatile memory 422 or 432, as depicted in FIG. 4.

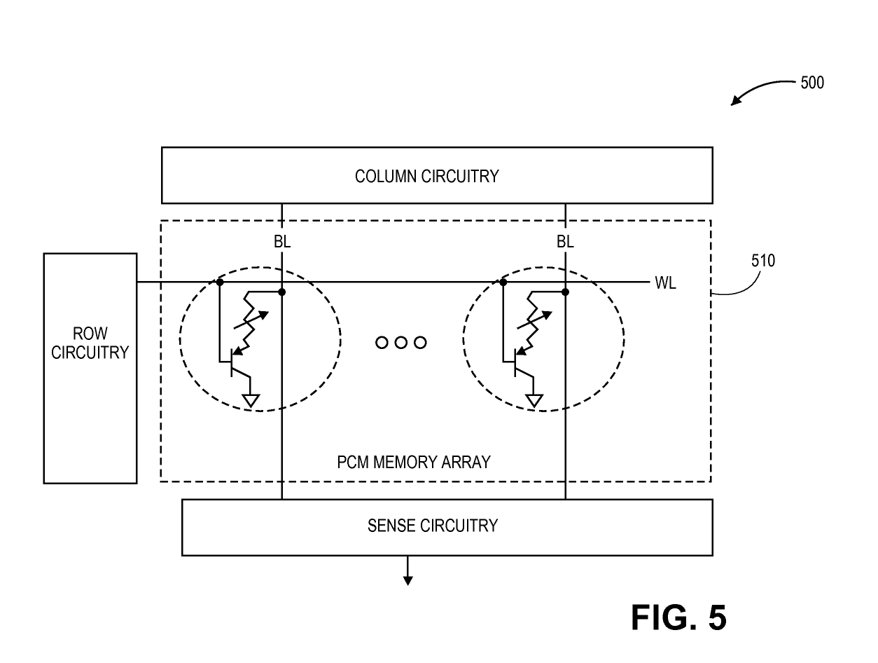

As described above, an executable memory configured to operate at least a portion of an executable program in the executable non-volatile memory may include an array of phase-change memory cells. FIG. 5 illustrates a phase change memory cell in an array of phase-change memory cells configured to be included in a method for operating at least a portion of an executable program in the array of phase-change memory cells, in accordance with an embodiment of the present invention.

In an aspect of embodiments of the present invention, a phase-change memory cell array 500 includes memory cells that are composed of a storage material in combination with a selector device. In an embodiment, a phase-change memory cell 510 is composed of alloys of elements of group VI of the periodic table, elements such as Te or Se that are referred to as chalcogenides or chalcogenic materials. Chalcogenides may be used advantageously in phase change memory cells to provide data retention and remain stable even after the power is removed from the nonvolatile memory. Taking the phase change material as Ge₂Sb₂Te₅ for example, two phases or more are exhibited having distinct electrical characteristics useful for memory storage. In an embodiment, each phase-change memory cell 510 includes has a selector device and a memory element. Although the array 500 is illustrated with bipolar selector devices, it should be noted that alternative embodiments may use CMOS selector devices or diodes to identify and selectively change the electrical properties (e.g. resistance, capacitance, etc.) of the chalcogenide material through the application of energy such as, for example, heat, light, voltage potential, or electrical current. The chalcogenide material may be electrically switched between different states intermediate between the amorphous and the crystalline states, thereby giving rise to a multilevel storing capability. To alter the state or phase of the memory material, this embodiment illustrates a programming voltage potential that is greater than the threshold voltage of the memory select device that may be applied to the memory cell. An electrical current flows through the memory material and generates heat that changes the electrical characteristic and alters the memory state or phase of the memory material.

By way of example, heating the phase-change material to a temperature above 900° C. in a write operation places the phase change material above its melting temperature (T_{M}). Then, a rapid cooling places the phase-change material in the amorphous state that is referred to as a reset state where stored data may have a ‘1’ value. Taking Ge₂Sb₂Te₅ as an example, the time between achieving the melting temperature Tm and quenching after the local heating to achieve the amorphous phase may be less than 50 nanoseconds. On the other hand, to program a memory cell from reset to set, the local temperature is raised higher than the crystallization temperature (Tx) for a time longer than 50 nanoseconds (for Ge₂Sb₂Te₅) to allow complete crystallization. The phase-change material in the crystalline form is referred to as a set state and stored data may have a ‘0’ value. Thus, the cell can be programmed by setting the amplitude and pulse width of the current that will be allowed through the cell. In summary, a higher magnitude, fast pulse will amorphize the cell, whereas a moderate magnitude, longer pulse will allow the cell to crystallize. In a read operation, the bit line (BL) and word line (WL) are selected and an external current is provided to the selected memory cell. To read a chalcogenide memory device, the current difference resulting from the different device resistance is sensed. It is then determined whether data stored in the selected memory cell is a ‘1’ or ‘0’ based on a voltage change caused by a resistance of the phase-change material of the selected memory cell. It is to be appreciated that the association of reset and set with amorphous and crystalline states, respectively, is a convention and that at least an opposite convention may be adopted.

Thus, a method for operating at least a portion of an executable program in an executable non-volatile memory has been disclosed. In accordance with an embodiment of the present invention, the method includes determining, by a user input, at least a portion of an executable program for pinning in the executable non-volatile memory. The portion of the executable program is pinned to the executable non-volatile memory. The portion of the executable program is then executed from the executable non-volatile memory. In one embodiment, prior to the pinning and subsequent to the executing, power is removed from the executable non-volatile memory and then is restored to the executable non-volatile memory. In one embodiment, the executable non-volatile memory comprises a phase-change memory array.

What is claimed is:

1. A computer-implemented method for operating at least a portion of an executable program in an executable non-volatile memory, the method comprising:
determining, by a user input, at least a portion of an executable program for pinning in the executable non-volatile memory;
pinning the portion of the executable program to the executable non-volatile memory; and, subsequently,
executing the portion of the executable program from the executable non-volatile memory.

2. The computer-implemented method of claim 1, further comprising:
prior to the pinning and subsequent to the executing, removing power from the executable non-volatile memory; and
restoring power to the executable non-volatile memory.

3. The computer-implemented method of claim 1, wherein the executable non-volatile memory comprises a phase-change memory array.

4. The computer-implemented method of claim 3, wherein the phase-change memory array has a size selected from the group consisting of 4 gigabytes, 8 gigabytes and 16 gigabytes.

5. The computer-implemented method of claim 1, wherein the executable non-volatile memory is a NOR flash memory device.

6. A computer-implemented method for operating at least a portion of an executable program in an executable non-volatile memory, the method comprising:
profiling, by an operating system, to determine at least a portion of an executable program for pinning in the executable non-volatile memory;
pinning the portion of the executable program to the executable non-volatile memory; and, subsequently,
executing the portion of the executable program from the executable non-volatile memory.

7. The computer-implemented method of claim 6, wherein the profiling comprises determining the number of times the executable program has been accessed in a past timeframe.

8. The computer-implemented method of claim 6, further comprising:
prior to the pinning and subsequent to the executing, removing power from the executable non-volatile memory; and
restoring power to the executable non-volatile memory.

9. The computer-implemented method of claim 6, wherein the executable non-volatile memory comprises a phase-change memory array.

10. The computer-implemented method of claim 6, wherein the executable non-volatile memory is a NOR flash memory device.

11. A machine-accessible storage medium having instructions stored thereon which cause a data processing system to perform a method for operating at least a portion of an executable program in an executable non-volatile memory, the method comprising:
applying a user input or an operating system profile to determine at least a portion of an executable program for pinning in the executable non-volatile memory;
pinning the portion of the executable program to the executable non-volatile memory; and, subsequently,
executing the portion of the executable program from the executable non-volatile memory.

12. The machine-accessible storage medium of claim 11, wherein the operating system profile is applied, and wherein generating the operating system profile comprises determining the number of times the executable program has been accessed in a past timeframe.

13. The machine-accessible storage medium of claim 11, the method further comprising:
prior to the pinning and subsequent to the executing, removing power from the executable non-volatile memory; and
restoring power to the executable non-volatile memory.

14. The machine-accessible storage medium of claim 11, wherein the executable non-volatile memory comprises a phase-change memory array.

15. The machine-accessible storage medium of claim 11, wherein the executable non-volatile memory is a NOR flash memory device.

16. A wireless communication device, comprising:
a transceiver to receive over-the-air signals;
a processor core coupled to the transceiver; and
an executable non-volatile memory embedded with at least the first processor core, the executable non-volatile memory configured to be included in a method for operating at least a portion of an executable program in the executable non-volatile memory, the method comprising:
applying a user input or an operating system profile to determine at least a portion of an executable program for pinning in the executable non-volatile memory;
pinning the portion of the executable program to the executable non-volatile memory; and, subsequently,
executing the portion of the executable program from the executable non-volatile memory.

17. The wireless communication device of claim 16, wherein the operating system profile is applied, and wherein generating the operating system profile comprises determining the number of times the executable program has been accessed in a past timeframe.

18. The wireless communication device of claim 16, the method further comprising:
prior to the pinning and subsequent to the executing, removing power from the executable non-volatile memory; and
restoring power to the executable non-volatile memory.

19. The wireless communication device of claim 16, wherein the executable non-volatile memory comprises a phase-change memory array.

20. The wireless communication device of claim 16, wherein the executable non-volatile memory is a NOR flash memory device.
